(19) United States
(12) Patent Application Publication
(10) Pub. No.: US 2010/0277638 A1
(43) Pub. Date: Nov. 4, 2010

(54) IMAGE SPACE FOCUS

(76) Inventor: Thomas Craven-Bartle, Lund (SE)

Correspondence Address: MARSH, FISCHMANN & BREYFOGLE LLP, 8055 East Tufts Avenue, Suite 450, Denver, CO, 80237, US

(21) Appl. No.: 12/432,590

(22) Filed: Apr. 29, 2009

(51) Int. Cl. H04N 5/225

(52) U.S. Cl. 348/340; 348/E05.024

(57) ABSTRACT

A camera having a lens and a sensor between which one or more transparent plates can selectively be disposed. The plates may have different thickness or indices of refraction, or they may have the same thickness and index of refraction and various combinations of them can be employed. Alternatively, a single plate may be used. The single plate may have one or more regions of different thickness or index of refraction or both. One option may including removing any of the plates from the area between the lens and sensor. With any of these various embodiments, the object distance of best focus is varied when the plate is added or removed or different areas on a plate are used or different combinations of plates are added.

### BACKGROUND

Digital camera modules are currently incorporated into a variety of host devices. Such host devices include cellular telephones, personal data assistants (PDAs), computers, and so forth. Consumer demand for digital camera modules in host devices continues to grow.

Host device manufacturers prefer digital camera modules to be small, so that they can be incorporated into the host device without increasing the overall size of the host device. Further, there is an increasing demand for cameras in host devices to have higher-performance characteristics. One such characteristic that many higher-performance cameras (e.g., standalone digital still cameras) have is the ability to vary the focus of the camera lens in order to focus on subjects at different distances from the camera. Further, many of these cameras also have the ability for the camera to automatically focus on the subject located at the center of the image or to focus on one or more features in the image such as a face, a feature known as auto-focus. Typically, the focus of the camera is varied by moving the lens or elements of the lens along the optic axis. By moving the lens relative to the image sensor, the distance of an object that will appear in focus at the sensor of the camera is adjusted. This distance will be referred to herein as the object distance. In one example, the object distance may be varied by moving the lens through ten equally distributed steps of 10 to 15 μm each to vary the object distance from 0.1 m to infinity.

Using auto-focus systems, some camera modules achieve different object distances by moving the lens relative to the sensor to one of many (e.g., ten) different positions. For example, in some systems, object distances from 0.1 m to infinity can be achieved with 10 steps of 10 to 15 μm per step. In auto-focus systems, the lens may be moved by any of a variety of types of actuators, each of which have the characteristic of being relatively complex and expensive. One example of such an actuator type is the voice coil motor (VCM). Further, the motion achieved by common actuators may suffer from hysteresis, lens tilt, orientation dependence due to gravity, non-linear motion, and low repeatability. In addition, a challenge in designing actuators is to make them robust enough to withstand drop tests. Lastly, tolerance chains are typically long, due to the mechanical complexity of the actuators.

For less expensive fixed-focus cameras, it is typical to select an object distance less than infinity but which includes infinity within the depth of field range. In such case, the near end of the depth of field range may be further from the camera than might be desired by the user, since this near end of the depth of field range moves progressively further from the camera as the resolution (pixel count) of the camera is increased.

A hybrid of fixed-focus and auto-focus has recently been developed in which the lens is moved by an actuator between only two different positions. In one example, such an approach can move the near end of the depth of field of a lens with a 5MP sensor having a 1.4 μm pixel pitch from a distance of 0.90 m from the camera to a distance of 0.45 m from the camera, by moving the lens 15 μm. In such an example, it may be challenging to make an actuator system that moves the lens by such a small amount, due to mechanical tolerances, among other issues.

The foregoing examples of the related art and limitations related therewith are intended to be illustrative and not exclusive. Other limitations of the related art will become apparent to those of skill in the art upon a reading of the specification and a study of the drawings.

### SUMMARY

Disclosed herein is a camera that includes a sensor that captures an image, a lens that directs light toward the first sensor, and a movable transparent plate having a planar top surface and a planar bottom surface that is substantially parallel to the top surface. The transparent plate can be selectively inserted and selectively removed from an area between the sensor and the lens to cause light directed by the lens to pass through the plate before impinging on the sensor when the plate is inserted into the area and to cause light directed by the lens to impinge on the sensor without passing through the plate when the plate is removed from the area.

The plate may have a thickness t and an index of refraction n and the insertion of the glass plate changes an effective distance between the lens and the sensor by a distance d, where d=(n−1)t/n. The camera may further include at least one additional transparent plate having a planar top surface and a planar bottom surface that is substantially parallel to the top surface, that is selectively inserted and selectively removed from the area between the sensor and the lens. The first plate may have a thickness t₁ and an index of refraction n and the second plate may have a thickness t₂ and an index of refraction n and the insertion of both of the glass plates may change an effective distance between the lens and the sensor by a distance d, where d=(n−1)(t₁+t₂)/n. The first plate may have a thickness t₁ and an index of refraction n₁ and the second plate may have a thickness t₂ and an index of refraction n₂ and the insertion of both of the glass plates may change an effective distance between the lens and the sensor by a distance d, where d=((n₁−1)(t₁)/n₁)+((n₂−1)(t₂)/n₂). It may be the case that t₂ is approximately twice t₁ and the plates may be controlled so that any combination of the two plates may be in the area between the lens and the sensor, including neither of the plates, either one of the plates, or both of the plates. The insertion of the plate into the area between the sensor and the lens may increase the object distance of an object that is in focus at the sensor relative to the object distance when the plate is removed from the area.

Also disclosed is a camera that includes a sensor that captures an image, a lens that directs light toward the first sensor, and a movable transparent plate having a planar top surface and a planar bottom surface that is substantially parallel to the top surface. The transparent plate has at least two areas formed thereon, wherein one or both of (a) the thickness of the plate in the two areas is different and (b) the index of refraction of the plate in the two areas is different, and wherein the plate can be selectively moved so that a selected one of the areas of the plate is located in an area between the sensor and the lens to cause light directed by the lens to pass through the selected one of the areas on the plate before impinging on the sensor in one position of the plate and to cause light directed by the lens to pass through the other of the two areas on the plate before impinging on the sensor in an other position of the plate.

The plate may be pivotably mounted to the camera to allow the plate to be moved to the one position of the plate and to the other position of the plate. An actuator may be mounted to the camera and coupled to the plate to move the plate to the one position and the other position. The actuator may be manually operated by a camera user. The actuator may be driven by the camera. The camera may drive the actuator based on a user command. The two areas on the pivotable plate may be of different thicknesses and substantially the same index of refraction. The pivotable plate may be formed as at least a portion of a disk. The transparent plate may have three areas that are each of different thickness from the other and that are of substantially the same index of refraction. The transparent plate may include an IR filter.

Further disclosed is a camera that includes a sensor that captures an image, a lens that directs light toward the sensor, and a movable transparent plate assembly having a planar top surface and a planar bottom surface that is substantially parallel to the top surface. The transparent plate assembly includes two separate wedge-shaped members having their diagonal faces adjacent to each other, the plate assembly having at least a portion that is positioned between the sensor and the lens so that light passing through the lens passes through the plate assembly before impinging upon the sensor. The two separate wedge-shaped members can be moved relative to each other so that the overall thickness of the plate assembly is varied.

The index of refraction of the two separate wedge-shaped members may be substantially identical. The two separate wedge-shaped members may be composed of injection-molded plastic.

### BRIEF DESCRIPTION OF THE DRAWINGS

FIG. 1 is a schematic block diagram of portions of a camera.

FIG. 2 is an illustration of the location of a focused image with and without the presence of a transparent plate.

FIG. 3 is a transparent plate having two regions of different thickness.

FIG. 4 is a transparent plate having three regions of different thickness.

FIGS. 5a and 5b are of a transparent plate assembly composed of two different wedge-shaped members that can be slid relative to each other.

### DETAILED DESCRIPTION

The following description is not intended to limit the invention to the form disclosed herein. Consequently, variations and modifications commensurate with the following teachings, and skill and knowledge of the relevant art, are within the scope of the present invention. The embodiments described herein are further intended to explain modes known of practicing the invention and to enable others skilled in the art to utilize the invention in such, or other embodiments and with various modifications required by the particular application(s) or use(s) of the present invention.

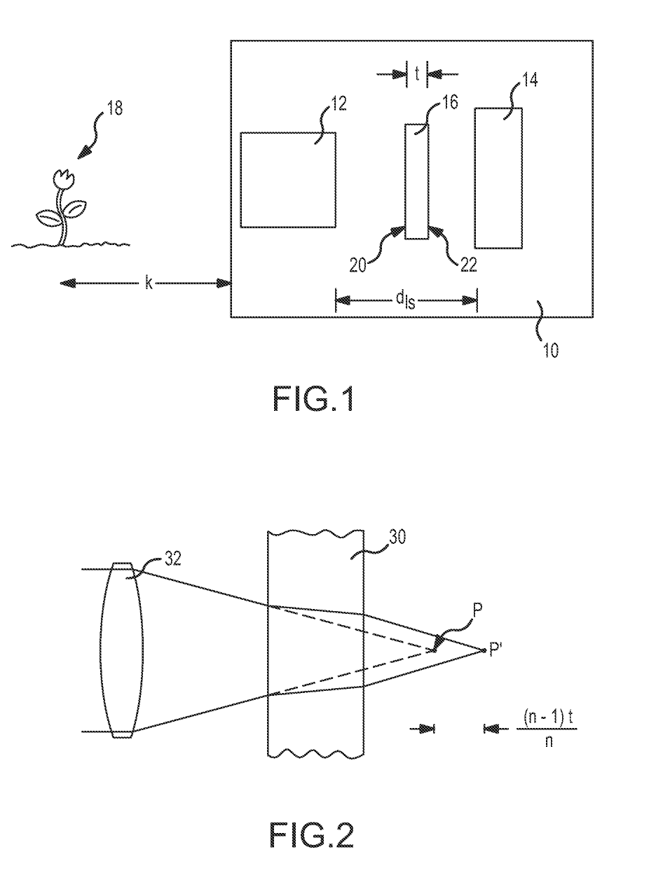

FIG. 1 shows a portion of a camera 10 employing image space focus. The camera 10 includes a lens 12 that directs light passing therethrough toward an image sensor 14. Between the lens 12 and the sensor 14 is a transparent plate 16 that changes the effective distance from the lens 12 to the sensor 14. As can be seen, the camera 10 is facing an object 18 that is located at a distance k from the camera 10.

The transparent plate 16 may be composed of any suitable material, such as glass, composite, plastic, and so forth. The plate 16 has a thickness t and an index of refraction n that is greater than the index of refraction of air (which is substantially equal to 1). In one example, the plate 16 has a pair of substantially planar surfaces 20 and 22 that are substantially parallel to each other and substantially orthogonal to an optic axis of the sensor 14 and lens 12.

FIG. 2 shows the effect of a transparent plate 30 on the image side of a lens 32. If the plate 30 were not present, an object (not shown) at a given object distance would be focused at location P. The light refracted by the lens 32 is shown in dashed lines for the case where the plate 30 is not present. The light refracted by the lens 32 from the object at the same given distance is shown in solid lines for the case where the plate 30 is present. In this latter case, the light is focused at location P′. As shown in FIG. 2, the location P is spaced from the location P′ by a distance approximately equal to (n−1)t/n, if the plate has a thickness t and an index of refraction n and the system exists in ambient air having an index of refraction of 1. Of course, in the case where the sensor and lens are kept stationary relative to each other, the effect of inserting the glass plate between the sensor and the lens is that while the sensor remains at the location designated as P, the object distance that will result in an optimally-focused image at location P is increased. Thus, by inserting a glass plate the object distance is increased.

The sensor 14 is located at a distance of dₗₛ from the lens 12. The presence of the transparent plate 16 between the lens 12 and the sensor 14 effectively changes the distance between the lens 12 and the sensor 14 by a distance of

d=(n−1)t/n (1)

It can be appreciated that, by changing the effective distance between the lens 12 and the sensor 14 by adding the plate 16, the object distance of the camera is increased. Conversely, when the transparent plate 16 is removed from between the lens 12 and the sensor 14, the object distance of the camera is decreased. As stated previously, while it is the effective distance from the lens 12 to the sensor 14 that we have discussed being varied, that is the case for light coming from an object located at a given distance from the lens 12. In actuality, the sensor 14 is not moved, but instead is maintained at a fixed distance relative to the lens 12. When the plate 16 is present, objects at a greater distance are focused at the sensor 14 as compared to when the plate 16 is not present.

Thus, the object distance of the camera 10 can be varied by selectively inserting or removing the transparent plate 16 from an area 24 between the lens 12 and the sensor 14. Further, the object distance can be varied without the need to move either the lens 12 or the sensor 14. One typical material for the transparent plate 16 may be glass having an index of refraction of approximately 1.5. Inserting this value into equation (1) can be seen to change the effective distance d_{eff} by a value of t/3. So, for a plate 16 having a thickness of 45 μm, the effective distance d_{eff} is changed by 15 μm. Increasing this effective distance increases the object distance of the camera 10 by a significant amount. Alternatively, instead of glass, injection-molded plastic could be used as it may be easier to produce than a glass plate having a thickness of only 45 μm. Since, the index of refraction of the plastic may be lower than 1.5 (possibly in the range of 1.3 to 1.5), the thickness of the plastic plate may be even less than 45 μm, but that may be easier to produce than producing a thin glass plate. No matter the material used, it is a beneficial characteristic that tolerance errors in the thickness of the plate only translate to changes to the effective distance from the lens to the sensor of approximately ⅓ of the tolerance errors.

There are many suitable techniques for selectively inserting or removing the transparent plate 16 from the area 24 between the lens 12 and the sensor 14. One example may include mounting the plate 16 on a pivot axis and employing an actuator to move the plate 16 about the pivot axis to selectively move the plate 16 into and out of the area 24. A similar mechanism is often employed to provide a mechanical shutter in some cameras, particularly in camera modules for mobile phones. The actuator may be driven by the camera 10 based on user command or automatically. Further as discussed below, the actuator may be driven mechanically by the user, thus providing a manual focus. Another example may include mounting the plate 16 in a slide mechanism that can be slid into or out of the area 24.

As can be appreciated, unlike AF actuators where the object distance is determined in part by how accurately the actuator is able to position the lens along the optic axis, the actuator in this system need not be as accurate since it merely has to move the plate in or out of the optical axis. Accordingly, this actuator is most likely to be less expensive than an AF actuator, even though it may be robust enough to withstand drop tests, use sufficiently low power, and be fast enough for an acceptable focusing speed to be achieved.

The depth of field range can be determined by selecting a maximum acceptable blur for images captured by the camera 10. In one example, the camera 10 may include a 3MP image sensor having a pixel pitch of 1.75 μm, and the maximum acceptable blur diameter may be specified to be two pixels (3.5 μm). Assuming that the sensor diagonal is 4.480 mm, the full diagonal DFOV is 63.1 degrees, the focal length is 3.648 mm, and the sensor includes an IR cut filter having a thickness of 0.3 mm (made of BSC7 glass), then the hyper focal distance (object distance best focused at the sensor) is 1.358 m. As the object distance is increased or decreased from this hyper focal distance, the blur of the object appearing in the image increases. The depth of field (DOF) is the range between the points where the maximum acceptable blur is reached. In this case, this range is from 0.680 m to infinity. This arrangement will allow the user to capture acceptable images as long as the object is located between 0.680 m and infinity.

To allow the user to capture acceptable images at any distance less than 0.680 m, one solution is to decrease the thickness of the IR cut filter. As can be appreciated, this is similar to removing a transparent plate having a thickness equal to the amount by which the IR cut filter is decreased in thickness. For example, if the IR cut filter were to be decreased in thickness from 300 μm to 243 μm, that would be a decrease of 57 μm. Using the ratios above (assuming the ratio of the index of refraction of the IR cut filter to the index of refraction of air is 1.5), then the effective distance of the sensor from the lens would be changed by one-third of 57 μm or 19 μm. It so happens that moving the effective distance from the sensor to the lens by roughly this amount, moves the DOF until the far end of the DOF is 0.680 m from the camera 10 and the near end is much closer to the camera 10. Thus, in one arrangement, a single plate (that also functioned as the IR cut filter) that has at least two areas of different thickness on the plate (roughly thicknesses of 300 μm and 250 μm) could be used to achieve two different selectable DOFs for the camera 10. Alternatively, the single plate could have three or more areas of different thickness (e.g., 300 μm, 250 μm, 200 μm, . . . ) to provide three or more DOF ranges.

Whenever additional optical elements (such as one or more plates 16) are inserted into the optical path between the lens 12 and the sensor 14, aberrations in the system will increase. Simulations have revealed, however, that the addition of one or two plates will not significantly degrade the image.

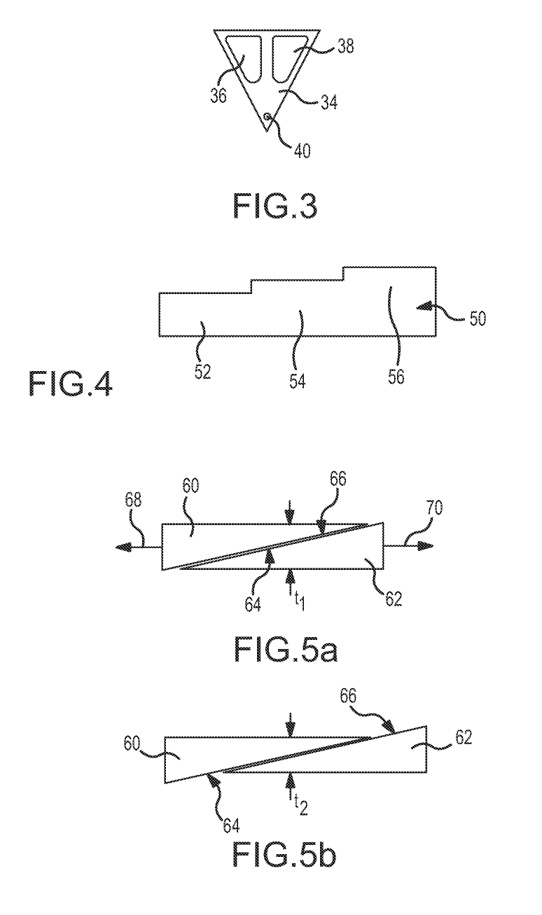

One variation of the camera described above is one in which there are a plurality of transparent plates 16, any one of which or combinations of which may be inserted into the area 24. These different plates 16 may have different thicknesses or different indices of refraction. In this manner, the object distance of the camera 10 can be changed to any one of a plurality of distances. For example, with one plate having a thickness of 45 μm and the other having a thickness of 90 μm, then total plate thicknesses of 0 μm, 45 μm, 90 μm, and 135 μm could be achieved. In such a variation, the different plates could be of the same thickness and index of refraction or either or both of those characteristics could be different. As a further variation, these different plates 16 may be joined or integrally formed together, such as on a disk 34 (FIG. 3, with two areas 36, 38 of different thickness, the plate pivoting about a pivot axis 40) or a plate 50 (FIG. 4, with three areas 52, 54, 56 of different thickness) (by way of non-limiting examples), so that any one of them may be slid or rotated into the area 24. As a still further variation, these different types of plates 16 may be arranged so that only one of them at a time can be inserted into the area 24. For example, two relatively-thick plates 16 of different thickness could be used. For example the plates could have thicknesses of 200 μm and 245 μm, respectively. In the case of two plates integrally formed in one injection-molded part, the thickness deviation between the two plates is likely to be very small and this will result in a small tolerance for the focus step size. In any of these variations, it may be possible to provide a macro (close DOF) setting for the camera by selectively removing all of the plates. If this is to be allowed, then it may be desirable to provide other means of providing IR filtering to the sensor.

FIGS. 5a and 5b show an arrangement where the transparent plate is achieved with two different wedge-shaped plates 60 and 62, each having a diagonal face 64 and 66, respectively. The plates 60 and 62 are oriented and arranged so that the diagonal faces 64 and 66 are adjacent to each other. They can be slid relative to each other in the directions of arrows 68 and 70 from a first position (FIG. 5a) in which the plates 60, 62 have a first combined thickness t₁ to multiple other positions (one of which is shown in FIG. 5b) in which the plates 60, 62 have a combined thickness t₂ that is less than the first combined thickness t₁.

As another alternative to all of the embodiments discussed herein, the actuator could be completely or partially replaced with a lever, knob, pin, or the like, accessible to the user so that the user could move the plate(s) and thereby select the DOF range.

A further alternative to all of the embodiments discussed herein would be to utilize a plate including a material, such as an electro-optic material, that has a variable index of refraction where the index of refraction may be a function of the voltage applied thereto. By applying different voltages, the camera can change the object distance of best focus without moving the plate.

Another variation that could potentially apply to any of the above embodiments would be for the movable plate to have a surface that can brush over the top of the IR filter so as to remove debris that may have collected thereon and may potentially cause a blemish in the captured image. Alternatively, the movable plate could include a wing or similar surface that causes an airflow across the IR filter when the plate is moved, to similarly clean off debris.

Any other combination of all the techniques discussed herein is also possible. The foregoing description has been presented for purposes of illustration and description. Furthermore, the description is not intended to limit the invention to the form disclosed herein. While a number of exemplary aspects and embodiments have been discussed above, those of skill in the art will recognize certain variations, modifications, permutations, additions, and sub-combinations thereof. It is therefore intended that the following appended claims and claims hereafter introduced are interpreted to include all such variations, modifications, permutations, additions, and sub-combinations as are within their true spirit and scope.

1. A camera, comprising:
a sensor that captures an image;
a lens that directs light toward the first sensor; and
a movable transparent plate having a planar top surface and a planar bottom surface that is substantially parallel to the top surface, wherein the transparent plate can be selectively inserted and selectively removed from an area between the sensor and the lens to cause light directed by the lens to pass through the plate before impinging on the sensor when the plate is inserted into the area and to cause light directed by the lens to impinge on the sensor without passing through the plate when the plate is removed from the area.

2. A camera as defined in claim 1, wherein the plate has a thickness t and an index of refraction n and the insertion of the glass plate changes an effective distance between the lens and the sensor by a distance d, where d=(n−1)t/n.

3. A camera as defined in claim 1, further including at least one additional transparent plate having a planar top surface and a planar bottom surface that is substantially parallel to the top surface, that is selectively inserted and selectively removed from the area between the sensor and the lens.

4. A camera as defined in claim 3, wherein the first plate has a thickness t₁ and an index of refraction n and the second plate has a thickness t₂ and an index of refraction n and the insertion of both of the glass plates changes an effective distance between the lens and the sensor by a distance d, where d=(n−1)(t₁+t₂)/n.

5. A camera as defined in claim 3, wherein the first plate has a thickness t₁ and an index of refraction n₁ and the second plate has a thickness t₂ and an index of refraction n₂ and the insertion of both of the glass plates changes an effective distance between the lens and the sensor by a distance d, where d=((n₁−1)(t₁)/n₁)+((n₂−1)(t₂)/n₂).

6. A camera as defined in claim 1, wherein t₂ is approximately twice t₁ and the plates can be controlled so that any combination of the two plates may be in the area between the lens and the sensor, including neither of the plates, either one of the plates, or both of the plates.

7. A camera as defined in claim 1, wherein the insertion of the plate into the area between the sensor and the lens increases the object distance of an object that is in focus at the sensor relative to the object distance when the plate is removed from the area.

8. A camera, comprising:
a sensor that captures an image;
a lens that directs light toward the first sensor; and
a movable transparent plate having a planar top surface and a planar bottom surface that is substantially parallel to the top surface, wherein the transparent plate has at least two areas formed thereon wherein one or both of (a) the thickness of the plate in the two areas is different and (b) the index of refraction of the plate in the two areas is different, and wherein the plate can be selectively moved so that a selected one of the areas of the plate is located in an area between the sensor and the lens to cause light directed by the lens to pass through the selected one of the areas on the plate before impinging on the sensor in one position of the plate and to cause light directed by the lens to pass through the other of the two areas on the plate before impinging on the sensor in an other position of the plate.

9. A camera as defined in claim 8, wherein the plate is pivotably mounted to the camera to allow the plate to be moved to the one position of the plate and to the other position of the plate.

10. A camera as defined in claim 9, wherein the two areas on the pivotable plate are of different thicknesses and substantially the same index of refraction.

11. A camera as defined in claim 9, wherein the pivotable plate is formed as at least a portion of a disk.

12. A camera as defined in claim 8, wherein an actuator is mounted to the camera and coupled to the plate to move the plate to the one position and the other position.

13. A camera as defined in claim 12, wherein the actuator is manually operated by a camera user.

14. A camera as defined in claim 12, wherein the actuator is driven by the camera.

15. A camera as defined in claim 14, wherein the camera drives the actuator based on a user command.

16. A camera as defined in claim 8, wherein the transparent plate has three areas that are each of different thickness from the other and that are of substantially the same index of refraction.

17. A camera as defined in claim 8, wherein the transparent plate includes an IR filter.

18. A camera, comprising:
a sensor that captures an image;
a lens that directs light toward the sensor; and
a movable transparent plate assembly having a planar top surface and a planar bottom surface that is substantially parallel to the top surface, wherein the transparent plate assembly includes two separate wedge-shaped members having their diagonal faces adjacent to each other, the plate assembly having at least a portion that is positioned between the sensor and the lens so that light passing through the lens passes through the plate assembly before impinging upon the sensor, wherein the two separate wedge-shaped members can be moved relative to each other so that the overall thickness of the plate assembly is varied.

19. A camera as defined in claim 18, wherein the index of refraction of the two separate wedge-shaped members is substantially identical.

20. A camera as defined in claim 18, wherein the two separate wedge-shaped members are composed of injection-molded plastic.
